(19) United States
(12) Patent Application Publication
(10) Pub. No.: US 2008/0294975 A1
(43) Pub. Date: Nov. 27, 2008

(54) SELECTABLE REVELATION OF CONTENT ATTRIBUTES FOR A HYPERLINK

(75) Inventors: Marcus L. Belvin, Raleigh, NC (US); Christopher M. Broglie, Doylestown, PA (US); Michael J. Frederick, San Diego, CA (US); David J. Hawkey, Schenectady, NY (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/751,513

(22) Filed: May 21, 2007

(51) Int. Cl. G06F 3/048; G06F 15/00; G06F 17/00; G06F 17/30; G06F 7/06

(52) U.S. Cl. 715/205; 707/4; 715/808; 707/E17.014

(57) ABSTRACT

Embodiments of the present invention address deficiencies of the art in respect to attribute revelation for a hyperlinked selection and provide a novel and non-obvious method, system and computer program product for user customizable hyperlink hover properties. In an embodiment of the invention, a method for selectable revelation of content attributes for a hyperlink can be provided. The method can include detecting a proximity event for a hyperlink referencing content including multiple attribute values for respective attributes. The method also can include retrieving hover properties for the hyperlink including a subset of the attributes. The method even also can include selecting a subset of attribute values corresponding to the subset of attributes. Finally, the method can include displaying the subset of attributes in a popup box for the hyperlink.

### BACKGROUND OF THE INVENTION

1. Field of the Invention

The present invention relates to the field hyperlinking electronic documents and more particularly to the visualization of hyperlink attributes.

2. Description of the Related Art

Content browsing refers to the retrieval and presentation of electronic content in a browser client. Content generally can include electronic documents, audio, audiovisual and video materials and imagery. Most commonly, content can be stored in a server environment and published for access by content consumers over a computer communications network such as the global Internet. Content consumers, in turn, can retrieve content over the network by reference to a network address for the content. Once retrieved, the content can be presented in a browser client including not only conventional visual browsers such as the venerable Web browser, but also in alternative browsers such as those deployed in pervasive devices and those supporting different modes of presentation such as the audible presentation of material.

Content published for consumption often can be retrieved according to a URI. As defined by the World Wide Web consortium, a URI is “the way you identify a point of content in the Internet space”. A common way to identify a point of content in Internet space is through an addressing scheme including a protocol identifier such as “http”, a physical server address such as “xyz.com”, a file system address such as “root/sub-level” and a file name such as “myfile.txt” such that the combined URI appears as: http://xyz.com/root/sub-level/myfile.txt referring to the electronic document “myfile.txt”. For most conventional Web browsers, all content from the Web page down to the included graphics resources can be associated with and retrieved through a respective URI, also referred to as a hyperlink.

Activating a hyperlink in content in a content browser generally results in the display within the content browser of different content referenced by the hyperlink. In some circumstances, the activation of the hyperlink can result in the launching of a new content browser into which referenced content can be displayed or otherwise rendered. Of note, hyperlinked content is not limited to textual content, but also hyperlinked content can include multimedia elements or even files selected for download. Advanced Web applications utilize hyperlinks to initiate commands in a backend computing system such as the initiation of a database query or the submission of a form.

Oftentimes, in a data driven application adapted for interaction through a content browser, a hyperlink for a data item refers to detailed attributes for the data item. For example, a hyperlink for a product item may, upon activation, refer to detailed characteristics of the product item including size, quantity and price. As another example, a hyperlink for a person in a directory may, upon activation, refer to detailed characteristics of the person including age, gender and title. To access the attributes of the selection referenced in the hyperlink, however, requires the activation of the hyperlink. To the extent that an end user prefers to browse the attributes of many different selections, each referenced by a separate hyperlink, then can be a tedious process.

Theorists have recognized the inefficiencies associated with accessing a hyperlink and have proposed the use of a popup window to reveal attributes of content referenced by a hyperlink. In fact, the use of a popup window in general to reveal detailed information regarding a selection has been well documented with concrete examples evident in the technical space of the instant messenger and in the technical space of the calendaring and scheduling system. Even still, generally the use of a popup window to reveal attributes for a selection can be limited to hard coded, fixed set of attributes. In this regard, the use of a popup window to reveal attributes for an underlying selection require a priori knowledge of the underlying attributes in order to permit the hard coding of the popup window. Accordingly, the end user has little if any control over the revealed attributes for a selection referenced within a hyperlink.

### BRIEF SUMMARY OF THE INVENTION

Embodiments of the present invention address deficiencies of the art in respect to attribute revelation for a hyperlinked selection and provide a novel and non-obvious method, system and computer program product for user customizable hyperlink hover properties. In an embodiment of the invention, a method for selectable revelation of content attributes for a hyperlink can be provided. The method can include detecting a proximity event for a hyperlink referencing content including multiple attribute values for respective attributes. The method also can include retrieving hover properties for the hyperlink including a subset of the attributes. The method even also can include selecting a subset of attribute values corresponding to the subset of attributes. Finally, the method can include displaying the subset of attributes in a popup box for the hyperlink.

In another embodiment of the invention, a content browsing data processing system can be configured for selectable revelation of content attributes for a hyperlink. The system can include a data store of user hover properties and hyperlink hover logic communicatively coupled to the data store. The logic can include program code enabled to detect a proximity event for a hyperlink referencing content comprising a plurality of attribute values for respective attributes, to retrieve from the data store hover properties for the hyperlink comprising a subset of the attributes, to select a subset of attribute values corresponding to the subset of attributes, and to display the subset of attributes in a popup box for the hyperlink. As an example, the proximity event can include a hover event or a right click event.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for selectable revelation of content attributes for a hyperlink;

FIG. 2 is a schematic illustration of a content browsing data processing system configured for selectable revelation of content attributes for a hyperlink; and,

FIG. 3 is a flow chart illustrating a process for selectable revelation of content attributes for a hyperlink.

### DETAILED DESCRIPTION OF THE INVENTION

Embodiments of the present invention provide a method, system and computer program product for selectable revelation of content attributes for a hyperlink. In accordance with an embodiment of the present invention, an end user preference for a selected set of attributes for linked content can be stored in association with a document browsing system. Subsequently, a document can be served to the end user including at least one hyperlink disposed within the document referencing the linked content. Responsive to the detection of a proximity event for the hyperlink, the user preferred attributes for the linked content can be retrieved and only those attribute values for the selected set of attributes can be revealed in a pop up box in association with the hyperlink. In this way, the end user can customize the selected set of attribute values to be revealed in the popup box and need not activate the hyperlink to visualize the attribute values.

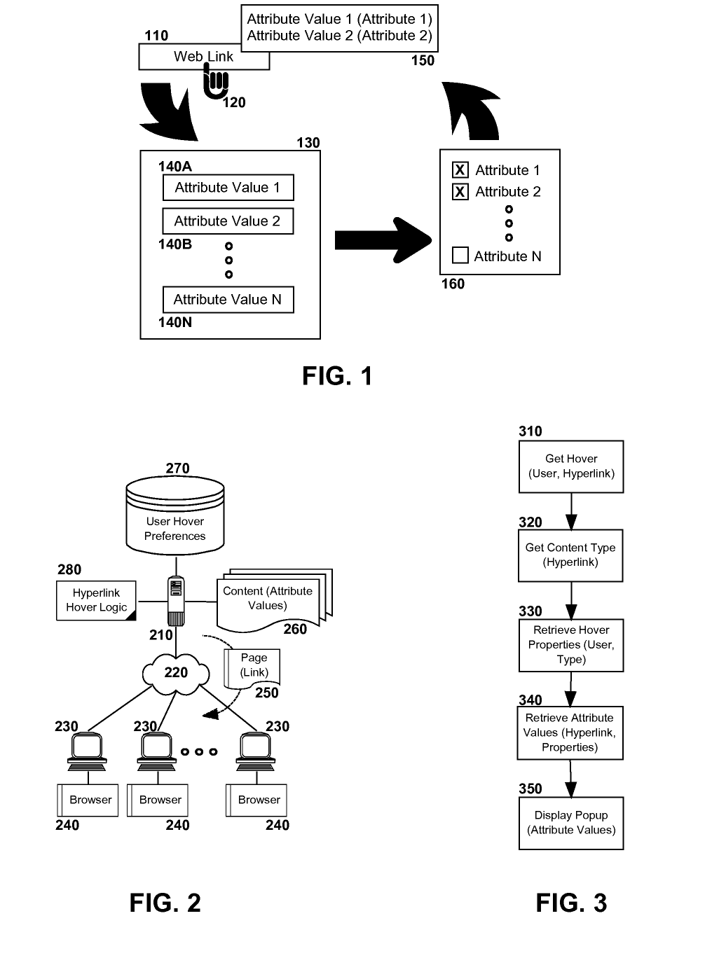

In illustration, FIG. 1 is a pictorial illustration of a process for selectable revelation of content attributes for a hyperlink. As shown in FIG. 1, a hyperlink 110 can reference content 130 including one or more attribute values 140A, 140B, 140N. User hover properties 160 can be established for the content 130 specifying which of the attribute having attribute values 140A, 140B, 140N in the content 130 are to be displayed in a popup box 150 responsive to a proximity event such as a mouse-over with pointer 120, or a right-click on pointer 120. In this way, an user can selectably view only those attribute values of interest in the popup box 150.

In further illustration, FIG. 2 schematically depicts a content browsing data processing system configured for selectable revelation of content attributes for a hyperlink. The system can include a server computing platform 210 configured for coupling to one or more client computing platforms 230 over computer communications network 220. Each of the client computing platforms 230 can include a browser 240 configured to render pages 250 provided by the server computing platform 210. The pages 250 can include one or more hyperlinks to content 260, the content 260 including one or more attribute values.

Notably, hyperlink hover logic 280 can be distributed with individual documents including hyperlinks to pages 250. The hyperlink hover logic 280 can include program code enabled to detect and respond to proximity events to hyperlinks within a corresponding page. In response to detecting a proximity event to a hyperlink, the program code of the hyperlink hover logic 280 can identify content 260 referenced within the hyperlink and display only those attribute values for attributes selected in user hover preferences 270 for the page type in a popup box for the hyperlink. In this regard, the user hover preferences 270 can include a table of attributes for a page type of content and user selected by the user for inclusion in a popup box responsive to the detection of a proximity event to a hyperlink referencing content of the page type.

In yet further illustration of the operation of the hyperlink hover link 280, FIG. 3 is a flow chart depicting a process for selectable revelation of content attributes for a hyperlink. Beginning in block 310, a proximity event such as a hover can be detected in connection with a hyperlink and a user. In block 320 the content type for content referenced by the hyperlink can be determined and in block 330, hover properties can be retrieved for the user and content type. In particular, the hover properties can include a set of attributes for which attribute values for the content are to be displayed in a popup for the hyperlink. Thereafter, in block 340 the attribute values for the subset of attributes can be retrieved from the content and displayed in block 350 in a popup for the hyperlink.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for selectable revelation of content attributes for a hyperlink, the method comprising:
detecting a proximity event for a hyperlink referencing content comprising a plurality of attribute values for respective attributes;
retrieving hover properties for the hyperlink comprising a subset of the attributes;
selecting a subset of attribute values corresponding to the subset of attributes; and,
displaying the subset of attributes in a popup box for the hyperlink.

2. The method of claim 1, wherein detecting a proximity event for a hyperlink referencing content comprising a plurality of attribute values for respective attributes, comprises detecting a hover event for a hyperlink referencing content comprising a plurality of attribute values for respective attributes.

3. The method of claim 1, wherein detecting a proximity event for a hyperlink referencing content comprising a plurality of attribute values for respective attributes, comprises detecting a right click event for a hyperlink referencing content comprising a plurality of attribute values for respective attributes.

4. The method of claim 1, wherein retrieving hover properties for the hyperlink comprising a subset of the attributes, comprises retrieving hover properties for a user associated with the proximity event and a content type for the content referenced by the hyperlink.

5. A content browsing data processing system configured for selectable revelation of content attributes for a hyperlink, the system comprising:
a data store of user hover preferences; and,
hyperlink hover logic communicatively coupled to the data store, the logic comprising program code enabled to detect a proximity event for a hyperlink referencing content comprising a plurality of attribute values for respective attributes, to retrieve from the data store of hover preferences for the hyperlink comprising a subset of the attributes, to select a subset of attribute values corresponding to the subset of attributes, and to display the subset of attributes in a popup box for the hyperlink.

6. The system of claim 5, wherein the proximity event is a hover event.

7. The system of claim 5, wherein the proximity event is a right click event.

8. A computer program product comprising a computer usable medium embodying computer usable program code for selectable revelation of content attributes for a hyperlink, the computer program product comprising:
computer usable program code for detecting a proximity event for a hyperlink referencing content comprising a plurality of attribute values for respective attributes;
computer usable program code for retrieving hover properties for the hyperlink comprising a subset of the attributes;
computer usable program code for selecting a subset of attribute values corresponding to the subset of attributes; and,
computer usable program code for displaying the subset of attributes in a popup box for the hyperlink.

9. The computer program product of claim 8, wherein the computer usable program code for detecting a proximity event for a hyperlink referencing content comprising a plurality of attribute values for respective attributes, comprises computer usable program code for detecting a hover event for a hyperlink referencing content comprising a plurality of attribute values for respective attributes.

10. The computer program product of claim 8, wherein the computer usable program code for detecting a proximity event for a hyperlink referencing content comprising a plurality of attribute values for respective attributes, comprises computer usable program code for detecting a right click event for a hyperlink referencing content comprising a plurality of attribute values for respective attributes.

11. The computer program product of claim 8, wherein the computer usable program code for retrieving hover properties for the hyperlink comprising a subset of the attributes, comprises computer usable program code for retrieving hover properties for a user associated with the proximity event and a content type for the content referenced by the hyperlink.
